(19) United States
(12) Patent Application Publication
(10) Pub. No.: US 2023/0302947 A1
(43) Pub. Date: Sep. 28, 2023

(54) INFORMATION MANAGEMENT METHODS AND SYSTEMS OF ELECTRIC VEHICLE CHARGING STATION FOR ROAMING CHARGING

(71) Applicant: Noodoe Corporation, Taipei City (TW)

(72) Inventors: YU-TING LIOU, Taipei City (TW); CHIA-WEI HU, Taipei City (TW); YAN-MING CHEN, Taipei City (TW)

(21) Appl. No.: 18/067,912

(22) Filed: Dec. 19, 2022

(30) Foreign Application Priority Data
Mar. 22, 2022 (TW) 111110659

(51) Int. Cl. B60L 53/66; B60L 53/62; B60L 53/63; B60L 53/67

(52) U.S. Cl. CPC B60L 53/66; B60L 53/62; B60L 53/63; B60L 53/67

(57) ABSTRACT

Information management methods and systems of electric vehicle charging station for roaming charging are provided. First, a server obtains at least one first charging station data, which has first data format, corresponding to a first charging station operator. Then, at least one second charging station data, which has second data format, corresponding to a second charging station operator is obtained, wherein at least a part of the first data format and the second data format is different. After that, a charging station query request is received. In response to the charging station query request, the first and second charging station data are obtained, and format conversion operation is performed on the first or the second charging station data, so that the first and second charging station data have the same format, and the first and second charging station data are presented through a user interface.

### BACKGROUND OF THE INVENTION

### Field of the Invention

The disclosure relates generally to information management methods and systems of electric vehicle charging stations, and, more particularly to methods and systems for managing information of electric vehicle charging stations among charging station operators in a roaming charging environment.

### Description of the Related Art

Recently, with the rising awareness of environmental protection and electric vehicle technology advances, the development of electric vehicles powered by electrical energy to replace traditional vehicles powered by fossil fuels has gradually become an important goal in the automotive field, thus making electric vehicles become more and more popular. In order to increase the range and willingness to use electric vehicles, many countries or cities have begun to set up charging stations in public places to provide electricity to electric vehicles, and have also begun to plan the deployment of a large number of charging stations in urban areas or scenic areas, so as to make the charging of electric vehicles more convenient.

Currently, different electric vehicle charging stations can be set up and managed by different charging station operators. To provide a more user-friendly electric vehicle charging experience, many operators of electric vehicle charging stations have developed applications on mobile phones that allow users to search for electric vehicle charging stations, start charging, stop charging, and view charging progress and other functions. Individual charging station operators can invite users to become members and offer a variety of charging options to meet the needs of different users.

As electric vehicle users may carry out long-distance or cross-regional movement, such as traveling, and there may only be electric vehicle charging stations of a particular charging station operator in a particular area. As a result, it is often the case that members of one charging station operator goes to another charging station operator's electric vehicle charging station to charge their vehicles. In view of this, the industry refers to this behavior as “roaming charging”. In the case of “roaming charging”, an E-Mobility Service Provider (EMSP) can offer roaming contracts of charging for the users to provide electric vehicle charging services. The EMSPs can connect to charging station operators to provide roaming charging services.

In practice, the EMSP may also be a charging station operator. It must integrate the charging station information of different charging station operators to provide users with queries and display them in the corresponding user interface. As the charging station information from different charging station operators may have different data formats, errors may occur in the presentation of the data if the charging station information is not properly converted, thereby causing confusion and disruption to users.

### BRIEF SUMMARY OF THE INVENTION

In an embodiment of an information management method of electric vehicle charging station for roaming charging, a server first obtains at least one first charging station data corresponding to a first charging station operator, wherein the first charging station data has a first data format. Next, at least one second charging station data corresponding to a second charging station operator is obtained, wherein the second charging station data has a second data format, wherein at least a part of the first data format and the second data format is different. Thereafter, a charging station query request is received. In response to the charging station query request, the first charging station data and the second charging station data are obtained and a format conversion operation is performed on the first charging station data or the second charging station data, so that the first charging station data and the second charging station data have the same format and the first charging station data and the second charging station data are presented through a user interface.

An embodiment of an information management system of electric vehicle charging station for roaming charging comprises a first charging station operator, a second charging station operator and a server. The first charging station operator has at least one first charging station data, wherein the first charging station data has a first data format. The second charging station operator has at least one second charging station data, wherein the second charging station data has a second data format, and wherein at least a part of the first data format and the second data format is different. The server couples to the first charging station operator and the second charging station operator to obtain the at least one first charging station data corresponding to the first charging station operator and the at least one second charging station data corresponding to the second charging station operator. The server receives a charging station query request and obtains the first charging station data and the second charging station data in response to the charging station query request. The server performs a format conversion operation on the first charging station data or the second charging station data, so that the first charging station data and the second charging station data have the same format and the first charging station data and the second charging station data are presented through a user interface.

In some embodiments, the server belongs to the first charging station operator, and the server connects to the second charging station operator via a network to obtain the second charging station data, and performs the format conversion operation on the second charging station data to convert the second charging station data to a third charging station data with the first data formats according to the first data format and the second data format.

In some embodiments, the server periodically connects to the second charging station operator via the network to obtain the second charging station data and stores the second charging station data in a second database corresponding to the second charging station operator in the server. The first charging station data is stored in a first database corresponding to the first charging station operator in the server, and the first database is separate from the second database.

In some embodiments, the server provides a retrieval interface, wherein the retrieval interface comprises a filter to receive at least one corresponding filtering option, wherein the filtering option comprises a specific charging station operator, a specific area, a specific rate range, or a specific charging station type. A charging station query request is generated according to the at least one filtering option, and the server retrieves the first charging station data or the second charging station data matching the at least one filtering option according to the charging station query request.

In some embodiments, the first data format has a plurality of first fields and the second data format has a plurality of second fields. The server adjusts the first fields and the second fields during the format conversion operation so that the converted first charging station data and the second charging station data have the same fields.

Information management methods and systems of electric vehicle charging station for roaming charging may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of an information management system of electric vehicle charging station for roaming charging of the invention;

FIG. 2 is a schematic diagram illustrating another embodiment of an information management system of electric vehicle charging station for roaming charging of the invention;

FIG. 3 is a schematic diagram illustrating an embodiment of an electric vehicle charging station of the invention;

FIG. 4 is a schematic diagram illustrating an embodiment of a server of the invention;

FIG. 5 is a flowchart of an embodiment of an information management method of electric vehicle charging station for roaming charging of the invention;

FIG. 6 is a flowchart of another embodiment of a method for obtaining charging station operator data of the invention;

FIG. 7 is a flowchart of another embodiment of an information management method of electric vehicle charging station for roaming charging of the invention;

FIG. 8 is a flowchart of an embodiment of a method for performing a format conversion operation of the invention; and

FIG. 9 is a flowchart of another embodiment of a method for performing a format conversion operation of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

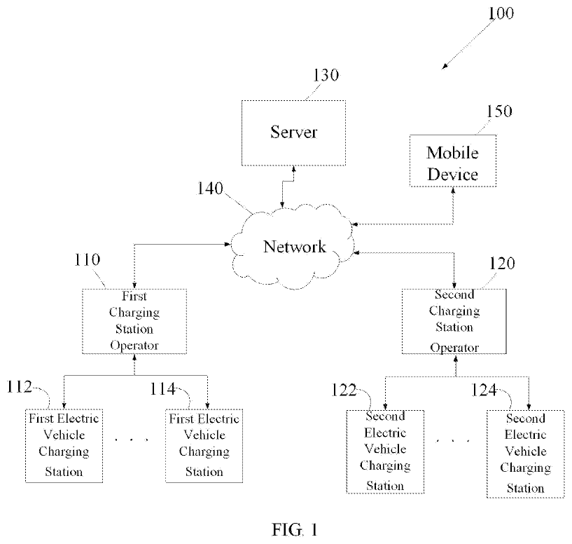

FIG. 1 is a schematic diagram illustrating an embodiment of an information management system of electric vehicle charging station for roaming charging of the invention. The information management system of electric vehicle charging station for roaming charging 100 comprises at least a first charging station operator 110, a second charging station operator 120, and a server 130 coupled to the first charging station operator 110 and the second charging station operator 120 via a network 140. The server 130 may belong to an electric vehicle service provider (also referred to as an “E-Mobility Service Provider (EMSP)”).

The first charging station operator 110 may manage at least one first electric vehicle charging station, such as electric vehicle charging stations 112, 114. Similarly, the second charging station operator 120 may manage at least one second electric vehicle charging station, such as electric vehicle charging stations 122, 124. it is noted that the electric vehicle charging stations may be located in one or different charging areas. Individual charging stations may provide a charging operation for electric vehicles. In some embodiments, the first charging station operator 110 may perform related charging management operations for the first electric vehicle charging station 112, 114 via a network. Similarly, a second charging station operator 120 may perform related charging management operations for the second electric vehicle charging stations 122, 124 via a network. The server 130 may communicate with the first charging station operator 110 via the network 140 to receive information about the first electric vehicle charging stations 112, 114, and information about the corresponding charging operations from the first charging station operator 110. Similarly, the server 130 may communicate with the second charging station operator 120 via the network 140 to receive information about the second electric vehicle charging stations 122, 124, and information about the corresponding charging operations from the second charging station operator 120. In some embodiments, the network 140 may be a wired network, a telecommunication network, and a wireless network, such as a Wi-Fi network.

It is noted that individual charging station operators can have a management server to receive various data from respective electric vehicle charging stations through the network, and transmit related signals to the electric vehicle charging stations. The electric vehicle charging stations can perform related operations according to the signals received from the manager server. For example, when an electric vehicle is coupled to the electric vehicle charging station through a charging gun of the electric vehicle charging station for a charging operation, the electric vehicle charging station can continuously transmit charging information corresponding the charging operation of respective electric vehicle via the network, and the manager server can receive the charging information of the corresponding charging operation from the electric vehicle charging station via the network.

It is noted that the user can connect the electric vehicle and the electric vehicle charging station to each other, such as inserting a charging gun into the charging port of the electric vehicle to send a charging request corresponding to the electric vehicle charging station to use the electric vehicle charging station to perform a charging operation for the electric vehicle. It is understood that, in some embodiments, the manager server of the charging station operator may directly or indirectly receive a charging request from a mobile device of the owner of the electric vehicle, and generate a charging authorization command based on the charging request and transmit it to the electric vehicle charging station via the network, so that the electric vehicle charging station outputs power to the electric vehicle, such as an electric scooter or an electric car, which is electrically connected to it, or prohibits the electric vehicle charging station from outputting power to the electric vehicle. It is reminded that, in some embodiments, the charging request may be accompanied by an identity authentication and/or a payment mechanism, and the charging authorization command will only be generated after the identity authentication and/or payment mechanism is completed. In some embodiments, the user of the electric vehicle can use his/her mobile device to download and install an application to generate a charging request through the user interface of the application. In some embodiments, the user can scan a Quick Response Code (QR code) on the electric vehicle charging station through the scanning function of the application to generate the above-mentioned charging request, thereby starting a charging operation. In some embodiments, the user can select a specific charging station through the application and execute an activation function to generate the above-mentioned charging request, thereby starting a charging operation. It is understood that, in some embodiments, the owner of the electric vehicle can use an RFID card to approach an induction area (not shown in FIG. 1) on the electric vehicle charging station to generate a corresponding charging request, and sent it to the manager server via the network. It is reminded that, in some embodiments, each user (the owner of the electric vehicle) can have an RFID card. It is noted that, in some embodiments, the owner of the electric vehicle may be a member of the server 130 (electric vehicle service provider) and wish to query the charging station operators and their electric vehicle charging stations for roaming charging through the interface provided by the server 130, the operation of which will be described later. It is noted that, roaming protocols can be implemented between the server 130 and the first charging station operator 110 and the second charging station operator 120 in order to obtain information about the relevant charging stations and the corresponding charging operations.

It is noted that, the mobile device 150 may be corresponded to the owner of the electric vehicle, which can be any electronic device capable of Internet access, such as mobile devices, such as mobile phones, smart phones, personal digital assistants, global positioning systems, and notebook computers. In some embodiments, the mobile device 150 can receive status information and notifications of the corresponding charging operation from the cloud management server via the network. In some embodiments, the status information and notification may include notifying that the electric vehicle has stopped charging, notifying that the vehicle needed to be moved, and/or notifying that the charging gun of the electric vehicle charging device has been disconnected from the electric vehicle, and so on. It is noted that, in some embodiments, when the owner of the electric vehicle is a member of the corresponding server 130 (the electric vehicle service provider), the mobile device 150 can receive status information and notifications of the corresponding charging operation from the server 130 via the network 140.

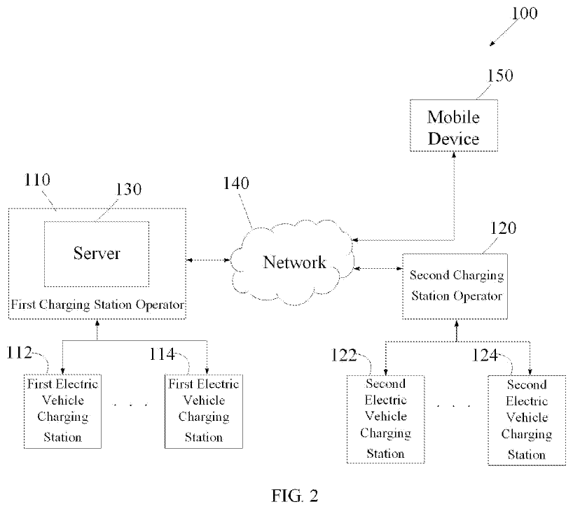

FIG. 2 is a schematic diagram illustrating another embodiment of an information management system of electric vehicle charging station for roaming charging of the invention. The information management system of electric vehicle charging station for roaming charging 100 comprises at least a first charging station operator 110, a second charging station operator 120, and a server 130 coupled to the first charging station operator 110 and the second charging station operator 120 via a network 140. In this embodiment, the first charging station operator 110 is also an electric vehicle service provider and the server 130 is the management server of the first charging station operator 110.

The server 130 of the first charging station operator 110 may manage at least one first electric vehicle charging station, such as electric vehicle charging stations 112, 114 via a network. Similarly, the manager server of the second charging station operator 120 may manage at least one second electric vehicle charging station, such as electric vehicle charging stations 122, 124. It is noted that the electric vehicle charging stations may be located in one or different charging areas. Individual charging stations may provide a charging operation for electric vehicles. The server 130 may receive information about the first electric vehicle charging stations 112, 114, and information about the corresponding charging operations from the first charging station operator 110 via the network. The server 130 may communicate with the second charging station operator 120 via the network 140 to receive information about the second electric vehicle charging stations 122, 124, and information about the corresponding charging operations from the second charging station operator 120. In some embodiments, the network 140 may be a wired network, a telecommunication network, and a wireless network, such as a Wi-Fi network.

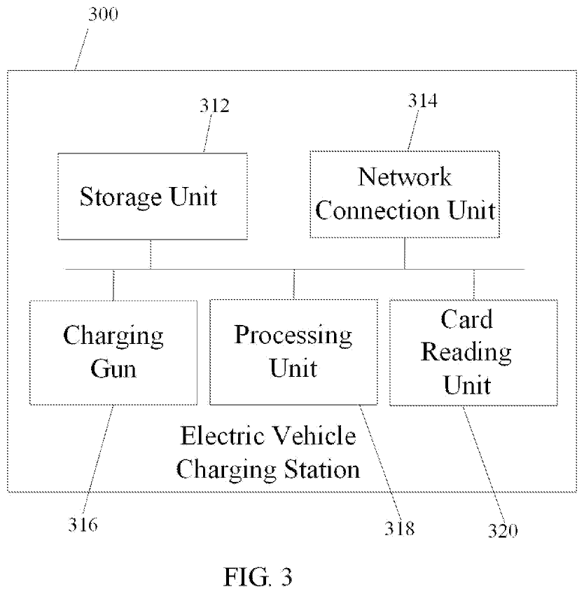

FIG. 3 is a schematic diagram illustrating an embodiment of an electric vehicle charging station of the invention. The electric vehicle charging station 300 shown in FIG. 3 can be applied to the electric vehicle charging stations (112, 114, 122, 124) in FIG. 1 or FIG. 2, which has processing and computing capabilities to perform charging management operations for the electric vehicle charging station. The electric vehicle charging station 300 has a network connection capability to receive, download or update various parameters and information required for charging management calculations.

The electric vehicle charging station 300 at least comprises a storage unit 312, a network connection unit 314, a charging gun 316, a processing unit 318, and a card reading unit 320. The storage unit 312 may be a memory or a database for storing and recording related data. The data may be related information such as charging station ID of the electric vehicle charging station and charging requests. It should be noted that the aforementioned information is only example, and the invention is not limited thereto. The network connection unit 314 can use a network, such as a wired network, a telecommunications network, and a wireless network, such as a Wi-Fi network, to receive, download, or update various parameters and information required for charging management operations. The charging gun 316 may include one or more charging connectors that meet the same charging interface specification or meet different charging interface specifications, and are electrically connected to the corresponding electric vehicle. The processing unit 318 can control the operations of related software and hardware in the electric vehicle charging station 300. It is noted that, in some embodiments, the processing unit 318 may be a general-purpose controller, a Micro-Control Unit, MCU, or a Digital Signal Processor, DSP, etc., to provide functions of data analysis, processing and calculation, but the present invention is not limited thereto. In one embodiment, the processing unit 318 may use the network connection unit 314 to transmit the power state of the corresponding electric vehicle through a network for a cloud management server for subsequent charging management. In another embodiment, the processing unit 318 can obtain the power parameter of a charging operation from the manager server, determine the output power according to the power parameter received from the manager server, and output the power to at least one electric vehicle through the charging gun 316 to perform the charging operation. The card reading unit 320 may be an RFID reading unit for sensing information of a physical card, such as RFID card. The information sensed from the RFID card may be a card identification code of the physical card.

It is understood that, the electric vehicle charging station 300 has an upper power limit value and a lower power limit value. Specifically, the electric vehicle charging station 300 can use the upper power limit value as the power parameter at the highest to output power to the electric vehicle during a charging operation. On the other hand, the electric vehicle charging station 300 needs to use the lower power limit value as the power parameter at least to output power to the electric vehicle during a charging operation. It must be noted that, charging stations of different brands and models may have different upper power limit values for output power and lower power limit values for output power. The present invention is not limited to any value, and the value may be different for different charging stations.

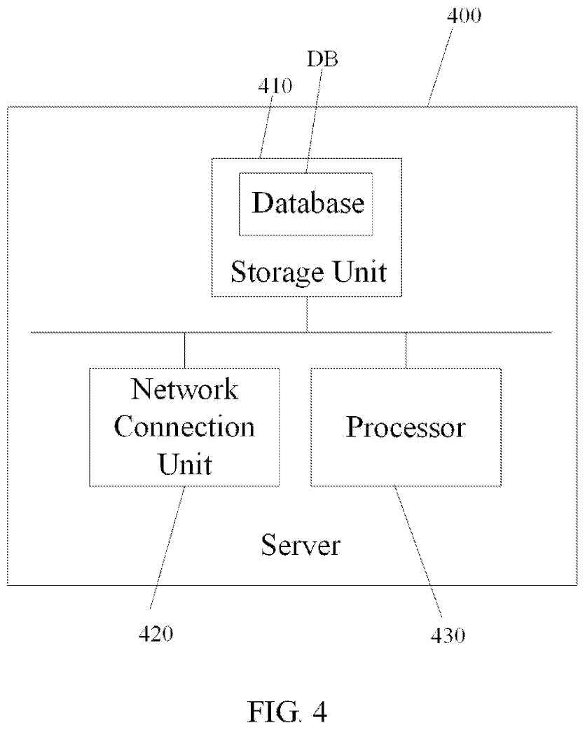

FIG. 4 is a schematic diagram illustrating an embodiment of a server of the invention. It is noted that the server 400 in FIG. 4 can be applied to the server 130 in FIG. 1. As shown in FIG. 4, the server 400 of the invention can be any processor-based electronic device, which comprises at least a storage unit 410, a network connection unit 420, and a processor 430. It is noted that, the server 400 can receive various data corresponding to a plurality of electric vehicle charging stations in individual charging fields from the charging station operators. The server 400 can directly or indirectly receive a charging request from a mobile device, and after completing actions such as identity confirmation in response to the charging request, generate a charging authorization command and transmit it to the corresponding electric vehicle charging station via the network. In response to the charging authorization command, the electric vehicle charging station is allowed to output power to an electric vehicle (for example, an electric motorcycle or an electric vehicle, etc.) that is electrically connected to it, or prohibit the electric vehicle charging station from outputting power to the electric vehicle.

The storage unit 410 may be a memory comprising a database DB, which can store and record related data, such as various data of the charging station operators/the electric vehicle charging stations. In addition, in some embodiments, the database DB may also record different users and corresponding user identification codes. In some embodiments, the database DB may record the format and fields of the charging station data corresponding to different charging station operators. Through the network connection unit 420, the server 400 can be coupled to and communicates with the electric vehicle charging stations via the network, such as a wired network, a telecommunications network, and a wireless network, such as a Wi-Fi network, and transmits related data/signals/commands to different electric vehicle charging stations via the network to control whether the electric vehicle charging stations output power, and specify power parameters for outputting power to electric vehicles. On the other hand, through the network connection unit 420, the server 400 can also be coupled and communicates with the mobile device via the network, and transmit related data/signals/commands to the mobile device via the network. The processor 430 can control the operations of related software and hardware in the server 400, and execute the information management methods of electric vehicle charging station for roaming charging of the invention. The relevant details will be described later. It is understood that, in some embodiments, the processor 430 may be a general-purpose controller, a Micro-Control Unit, MCU, or a Digital Signal Processor, DSP, etc., to provide data analysis, processing, and calculation functions.

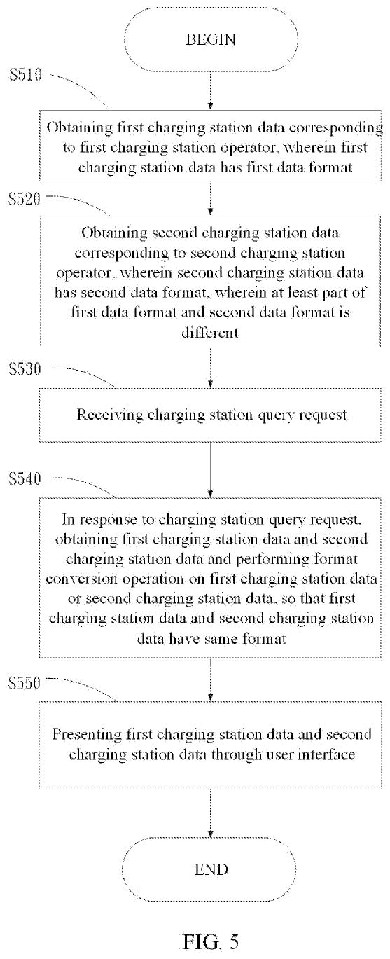

FIG. 5 is a flowchart of an embodiment of an information management method of electric vehicle charging station for roaming charging of the invention.

First, in step S510, the server obtains at least one first charging station data corresponding to a first charging station operator. Wherein, the first charging station data has a first data format. Next, in step S520, at least one second charging station data corresponding to the second charging station operator is obtained, wherein the second charging station data has a second data format, and wherein at least a part of the first data format and the second data format is different. Thereafter, in step S530, a charging station query request is received. In step S540, the first charging station data and the second charging station data are obtained in response to the charging station query request, and a format conversion operation is performed on the first charging station data or the second charging station data, so that the first charging station data and the second charging station data have the same format. When the format conversion operation is completed, in step S550, the first charging station data and the second charging station data are presented through a user interface.

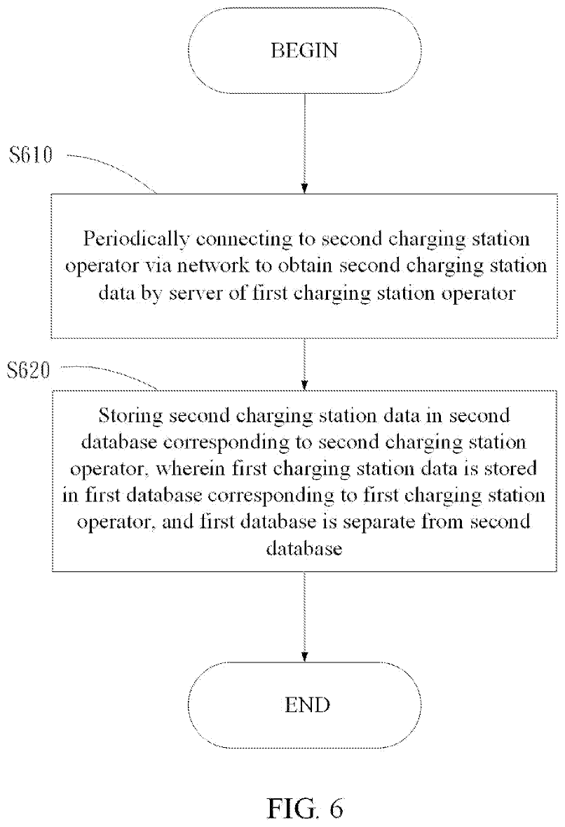

FIG. 6 is a flowchart of another embodiment of a method for obtaining charging station operator data of the invention. In this embodiment, the first charging station operator can be an electric vehicle service provider and the server of the first charging station operator can periodically obtain charging station information from other charging station operators, such as the second charging station operator, and store it in separate databases. First, in step S610, the server periodically connects to the second charging station operator via the network to obtain the second charging station data and, in step S620, stores the second charging station data in a second database corresponding to the second charging station operator in the server. It is noted that, the first charging station data of the first EV charging station corresponding to the first charging station operator is stored in a first database corresponding to the first charging station operator in the server, and the first database is separate from the second database.

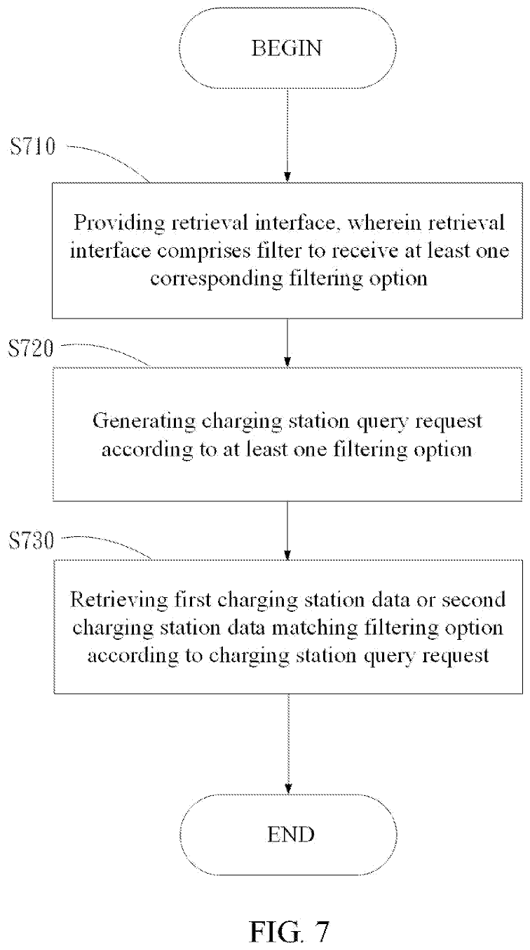

FIG. 7 is a flowchart of another embodiment of an information management method of electric vehicle charging station for roaming charging of the invention. In this embodiment, the server may provide a user interface to receive queries regarding the electric vehicle charging station from the corresponding user. First, in step S710, the server provides a retrieval interface, wherein the retrieval interface comprises a filter for receiving at least one corresponding filter option. It should be noted that, in some embodiments, the filtering options may include a specific charging station operator, a specific area, a specific rate range, and/or a specific charging station type. Next, in step S720, the server generates a charging station query request according to the at least one filtering option, and in step S730, retrieves the first charging station data and/or second charging station data matching that at least one filtering option according to the charging station query request.

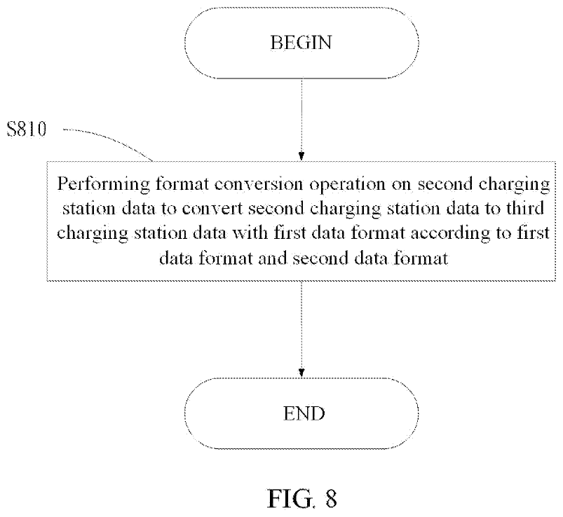

FIG. 8 is a flowchart of an embodiment of a method for performing a format conversion operation of the invention. First, in step S810, the server performs a format conversion operation on the second charging station data to convert the second charging station data to a third charging station data with the first data format according to the first data format and the second data format.

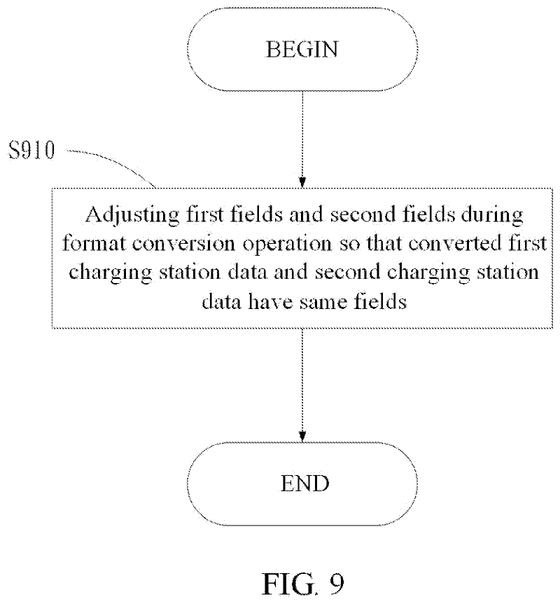

FIG. 9 is a flowchart of another embodiment of a method for performing a format conversion operation of the invention. In this embodiment, the first data format corresponding to the first electric vehicle charging station has a plurality of first fields, and the second data format corresponding to the second electric vehicle charging station has a plurality of second fields. First, in step S910, the first field and the second field are adjusted during the format conversion operation, so that the converted first charging station data and the second charging station data have the same fields.

Therefore, the information management methods and systems of electric vehicle charging station for roaming charging of the present invention can provide electric vehicle charging station information management between electric vehicle service providers and charging station operators during roaming charging, and convert charging station information appropriately to avoid possible errors in data presentation, thus reducing the chance of confusion and distraction for the users.

Information management methods of electric vehicle charging station for roaming charging, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. An information management method of electric vehicle charging station for roaming charging for use in a server coupled to a first charging station operator and a second charging station operator, comprising:
obtaining at least one first charging station data corresponding to the first charging station operator, wherein the first charging station data has a first data format;
obtaining at least one second charging station data corresponding to the second charging station operator, wherein the second charging station data has a second data format, wherein at least a part of the first data format and the second data format is different;
receiving a charging station query request;
in response to the charging station query request, obtaining the first charging station data and the second charging station data and performing a format conversion operation on the first charging station data or the second charging station data, so that the first charging station data and the second charging station data have the same format; and
presenting the first charging station data and the second charging station data through a user interface.

2. The method of claim 1, wherein the server belongs to the first charging station operator, and the server connects to the second charging station operator via a network to obtain the second charging station data, and the method further comprises performing the format conversion operation on the second charging station data to convert the second charging station data to a third charging station data with the first data format according to the first data format and the second data format.

3. The method of claim 2, wherein the server periodically connects to the second charging station operator via the network to obtain the second charging station data and stores the second charging station data in a second database corresponding to the second charging station operator in the server, wherein the first charging station data is stored in a first database corresponding to the first charging station operator in the server, and the first database is separate from the second database.

4. The method of claim 1, further comprising:
providing a retrieval interface by the server, wherein the retrieval interface comprises a filter to receive at least one corresponding filtering option, wherein the filtering option comprises a specific charging station operator, a specific area, a specific rate range, or a specific charging station type;
generating a charging station query request according to the at least one filtering option; and
retrieving the first charging station data or the second charging station data matching the at least one filtering option according to the charging station query request by the server.

5. The method of claim 1, wherein the first data format has a plurality of first fields and the second data format has a plurality of second fields, and the method further comprises adjusting the first fields and the second fields during the format conversion operation so that the converted first charging station data and the second charging station data have the same fields.

6. An information management system of electric vehicle charging station for roaming charging, comprising:
a first charging station operator comprising at least one first charging station data, wherein the first charging station data has a first data format;
a second charging station operator comprising at least one second charging station data, wherein the second charging station data has a second data format, and wherein at least a part of the first data format and the second data format is different; and
a server coupled to the first charging station operator and the second charging station operator, obtaining the at least one first charging station data corresponding to the first charging station operator and the at least one second charging station data corresponding to the second charging station operator, receiving a charging station query request, obtaining that first charging station data and the second charging station data in response to the charging station enquiry request, and performing a format conversion operation on the first charging station data or the second charging station data so that the first charging station data and the second charging station data have the same format and the first charging station data and the second charging station data are presented through a user interface.

7. The system of claim 6, wherein the server belongs to the first charging station operator, and the server connects to the second charging station operator via a network to obtain the second charging station data, and performs the format conversion operation on the second charging station data to convert the second charging station data to a third charging station data with the first data format according to the first data format and the second data format.

8. The system of claim 7, wherein the server periodically connects to the second charging station operator via the network to obtain the second charging station data and stores the second charging station data in a second database corresponding to the second charging station operator in the server, wherein the first charging station data is stored in a first database corresponding to the first charging station operator in the server, and the first database is separate from the second database.

9. The system of claim 6, wherein the server provides a retrieval interface, wherein the retrieval interface comprises a filter to receive at least one corresponding filtering option, wherein the filtering option comprises a specific charging station operator, a specific area, a specific rate range, or a specific charging station type, generates a charging station query request according to the at least one filtering option, and the server retrieves the first charging station data or the second charging station data that matches the at least one filtering option according to the charging station query request.

10. The system of claim 6, wherein the first data format has a plurality of first fields and the second data format has a plurality of second fields, and the server further adjusts the first fields and the second fields during the format conversion operation so that the converted first charging station data and the second charging station data have the same fields.

11. A machine-readable storage medium comprising a computer program, which, when executed, causes a device to perform an information management method of electric vehicle charging station for roaming charging, wherein the method comprises:
obtaining at least one first charging station data corresponding to a first charging station operator, wherein the first charging station data has a first data format;
obtaining at least one second charging station data corresponding to a second charging station operator, wherein the second charging station data has a second data format, wherein at least a part of the first data format and the second data format is different;
receiving a charging station query request;
in response to the charging station query request, obtaining the first charging station data and the second charging station data and performing a format conversion operation on the first charging station data or the second charging station data, so that the first charging station data and the second charging station data have the same format; and
presenting the first charging station data and the second charging station data through a user interface.
